(19) United States
(12) Patent Application Publication
(10) Pub. No.: US 2009/0238662 A1
(43) Pub. Date: Sep. 24, 2009

(54) Servo driven apparatus for trimming and transporting printed products in a trimmer

(75) Inventor: John Brian Duquette, Henniker, NH (US)

Correspondence Address: Davidson, Davidson & Kappel, LLC, 485 7th Avenue, 14th Floor, New York, NY, 10018, US

(73) Assignee: Goss International Americas, Inc., Dover, NH (US)

(21) Appl. No.: 12/077,493

(22) Filed: Mar. 18, 2008

(51) Int. Cl. B42B 9/00; B26D 5/20

(52) U.S. Cl. 412/16; 83/734

(57) ABSTRACT

A book trimmer is provided including an edge trimming knife driven by a drive motor and a conveyor downstream of the edge trimming knife driven by a servo motor. The drive motor also drives a section of the conveyor.

### BACKGROUND OF THE INVENTION

The present invention relates generally to a printed product trimmer and more specifically to a servo driven apparatus for trimming and transporting printed products in a printed product trimmer.

U.S. Pat. No. 3,733,947, which is incorporated by reference herein, discloses a machine for performing trimming operations upon the front and side edges of a book advancing through the machine. The machine includes a front edge trimming table which is reciprocated in a horizontal direction and receives a book from an infeed conveyor as the table moves in the direction of the conveyor. As the table continues to move in the direction of the infeed conveyor, the book is clamped to the table and the front edge of the book is trimmed.

U.S. Pat. No. 3,811,350 discloses a sheet material trimming method and apparatus. During operation of the trimmer mechanism, a continuous stream of untrimmed sheet material assemblages is transported from a collator or other source to the trimmer mechanism by a known chain type conveyor. Two sets of conveyor belts clampingly grip the sheet material assemblage to retain the orientation as it is trimmed at the first trim station, transported to the second trim station, and trimmed at the second trim station. An intermittent drive mechanism is provided for moving the conveyor belt through feed strokes.

U.S. Pat. No. 7,021,185, which is incorporated by reference herein, discloses a sheet material trimming apparatus used to trim books or other sheet material articles having either uniform thicknesses or thicknesses which vary within a range of thicknesses. The apparatus includes an infeed section from which books or sheet material articles are sequentially fed to a front trimmer assembly. The front trimmer assembly 24 registers the back or leading edge of a book relative to a front trim knife. While the front knife is moving with a front table, the front knife trims a trailing or front edge portion of the book or other sheet material article. A transfer belt assembly extends through the apparatus from the front trimmer assembly through a side trimmer assembly to a receiving conveyor. The transfer belt assembly sequentially moves partially trimmed books or other sheet material articles from the front trimmer assembly to the side trimmer assembly.

### BRIEF SUMMARY OF THE INVENTION

A book trimmer is provided including an edge trimming knife driven by a drive motor and a conveyor downstream of the edge trimming knife driven by a servo motor. The drive motor also drives a section of the conveyor.

### BRIEF DESCRIPTION OF THE DRAWINGS

The present invention is described below by reference to the following drawings, in which:

FIG. 1 shows a perspective view of a front knife area in a flying trimmer according to an embodiment of the present invention, with certain elements found in FIG. 11 omitted for clarity in showing an upper front knife and a lower front knife;

FIG. 2 shows a cross sectional perspective view of the front knife area shown in FIG. 1 and a chip gate;

FIG. 3 shows a perspective view of a lower knife area shown in FIG. 1;

FIG. 4 shows a perspective view of a portion of an infeed device advancing books to the front knife area shown in FIG. 1, which is shown schematically by the lower front knife, the upper knife, and a clamp;

FIG. 5 shows a schematic side view of the infeed device, lower knife, upper knife, and clamp shown in FIG. 4, and a downstream transport conveyor;

FIG. 6 shows a schematic side view of the embodiment shown in FIG. 5 with a book passing from the infeed device to the transport conveyor;

FIG. 7 shows a schematic side view of the embodiment shown in FIG. 5 with a book being released by the infeed device as the book is transported by the transport conveyor;

FIG. 8 shows a schematic side view of the embodiment shown in FIG. 5 with the clamp applying pressure to a book as the transport conveyor transports the book;

FIG. 9 shows a highly schematic view of the embodiment of the shown in FIGS. 5 to 8 with side knives added;

FIG. 10 shows a graph of horizontal velocities of the front knife, the side knives and the transport conveyor for complete revolutions of the front knife and the side knives according to the embodiment of the present invention shown in FIG. 9; and

FIG. 11 shows pulleys shown in FIG. 5 mounted on a front knife carriage shown in FIG. 1.

### DETAILED DESCRIPTION

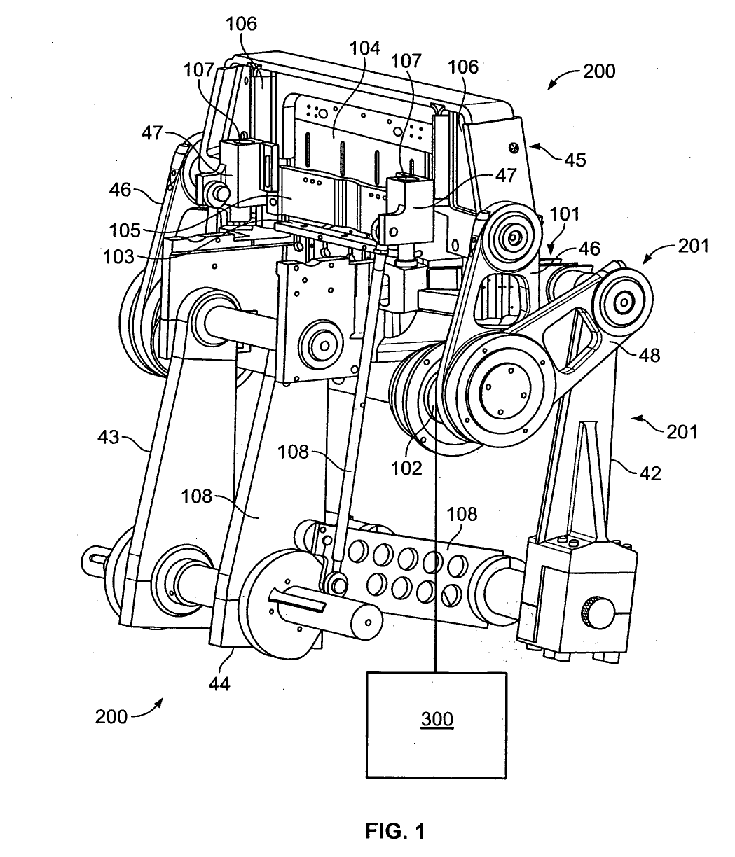

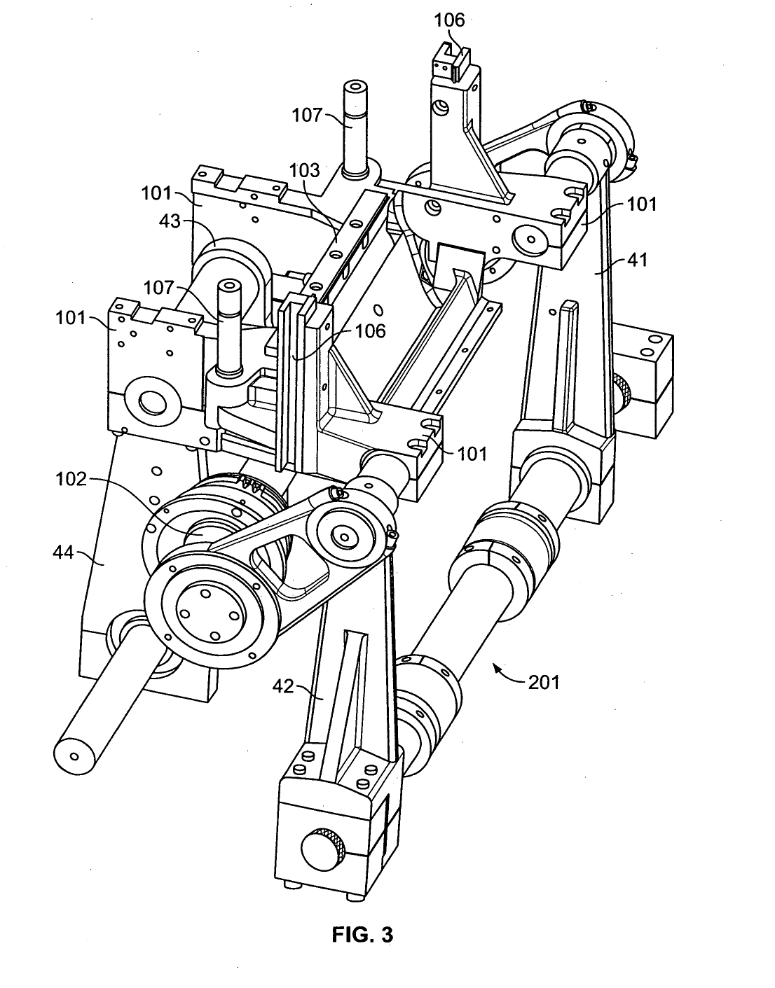

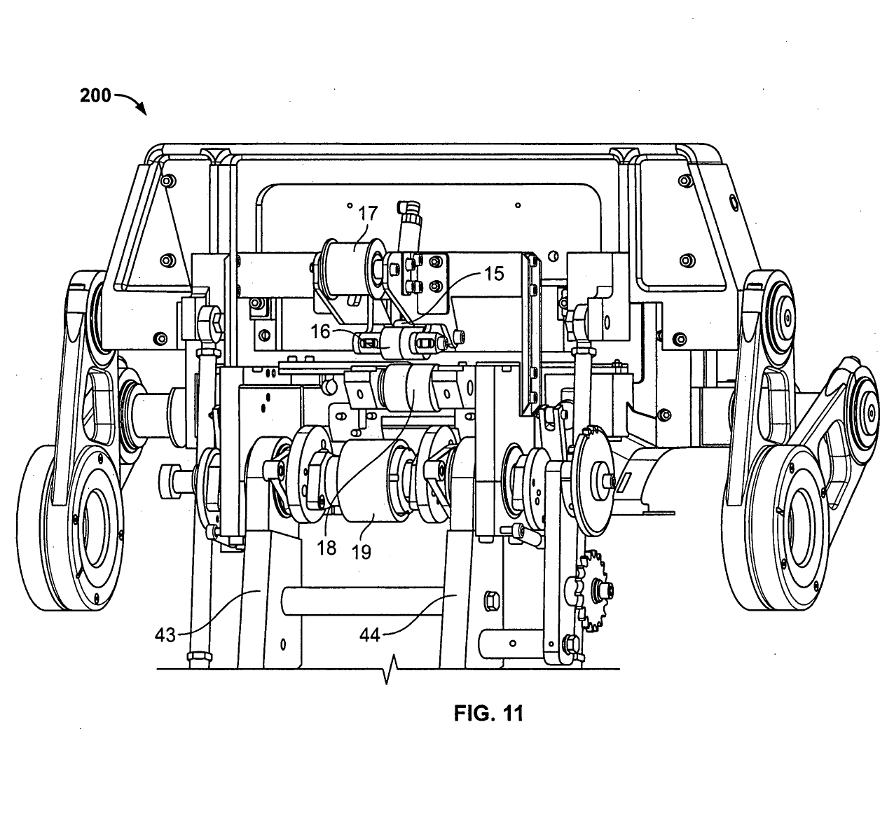

FIG. 1 shows a perspective view of a front knife area 200 in a flying trimmer according to an embodiment of the present invention, with certain elements found in FIG. 11 omitted for clarity in showing an upper front edge trimming knife 104 and a lower front edge trimming knife 103. Front knife area 200 includes a lower front knife area 201 and an upper knife assembly 45. Lower front knife area 201 includes a front knife carriage 101 and supporting levers 42, 43, 44 (lever 41 being hidden from view and being shown in FIG. 3) that allow front knife carriage 101 to be horizontally reciprocated back and forth by an eccentric crank 102, via links 48. Eccentric crank 102 is driven by a drive motor 300. In one embodiment drive motor 300 may be driven by a vector drive. Front knife carriage 101 supports lower front edge trimming knife 103, linear slides 106, and posts 107. Posts 107 can slidably support bearing blocks 47, which move up and down on posts 107. A clamp 105 for printed products is mounted to bearing blocks 47. Upper knife assembly 45 includes an upper front edge trimming knife 104 and is mounted on linear slides 106. Clamp 105 and upper knife assembly 45 are respectively arranged so that clamp 105 and upper knife assembly 45 travel with front knife carriage 101 when knife carriage 101 is reciprocated by eccentric crank 102. Upper knife assembly 45 is also reciprocated up and down by eccentric crank 102 to trim books passing through front knife area 200. Clamp 105 can be independently driven up and down by a cam and lever system 108 to engage books while books are trimmed by knives 103, 104.

When a book, or other printed product, is advanced to front knife area 200, clamp 105 can be driven down by cam and lever system 108, by sliding bearing blocks 47 downward, so clamp 105 fixedly engages the book. In a preferred embodiment the downward movement of clamp 105 may be timed with the horizontal movement of carriage 101 so the travel of the book is not disrupted and the book travels fluidly through the flying trimmer. After clamp 105 fixedly engages the book, upper knife assembly 45 can be reciprocated downward toward the book and upper front front edge trimming knife 104 can slice through the book and contact lower front edge trimming knife 103, trimming an edge of the book parallel to a spine of the book. Upper knife 104 is then reciprocated upward and clamp 105 is disengaged from the book. While clamp 105 engages the book and knives 103, 104 trim the book, knife carriage 101 can be reciprocated horizontally by eccentric crank 102 so that knives 103, 104 and clamp 105 travel at the same horizontal velocity as the book.

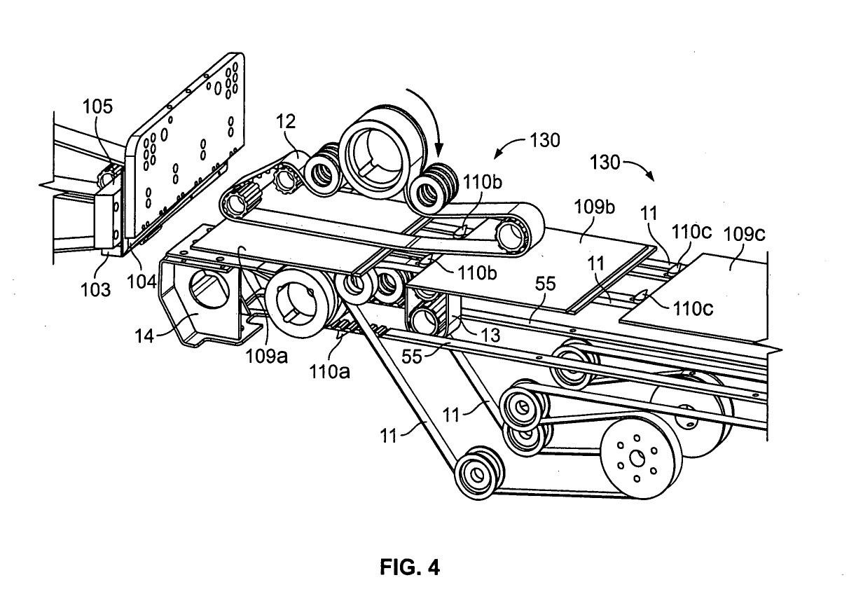

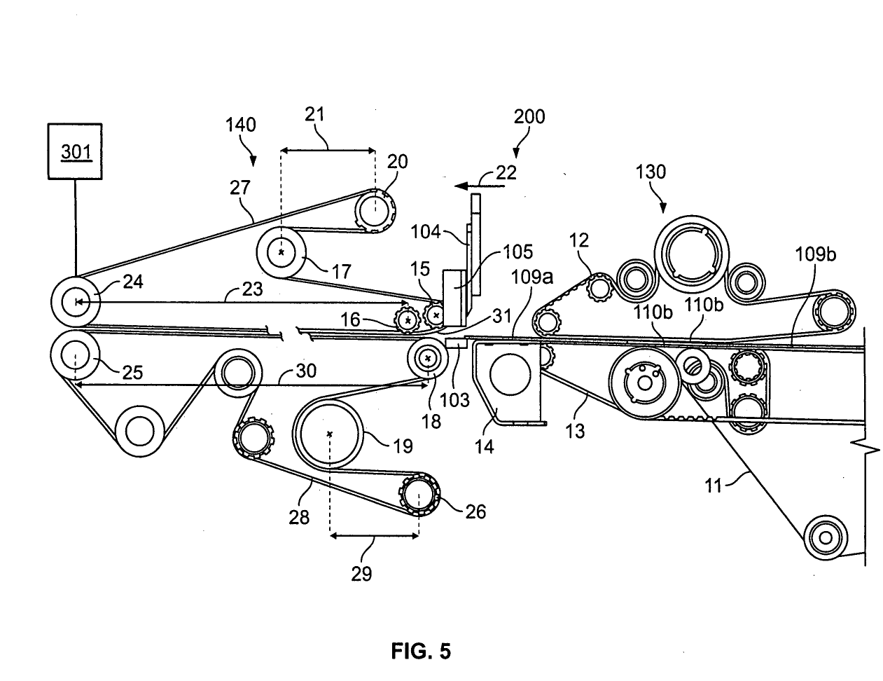

During front edge trimming, books are secured and transported by a transport conveyor 140 (FIG. 5). For each revolution of eccentric crank 102, front knife carriage 101 may complete a full revolution, reciprocating back and forth horizontally in relation to the path of the books to be trimmed, while upper knife 104 oscillates down, contacts lower knife 103, and trims a book during each revolution. Transport of books before and after books are trimmed, for example, is discussed in detail below in relation to FIGS. 4 to 10.

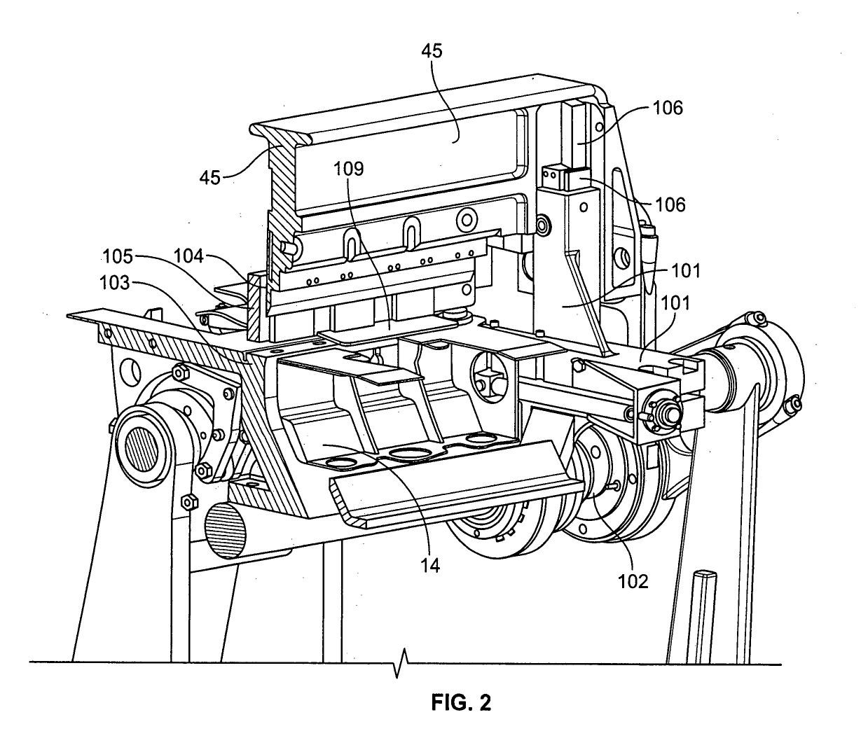

FIG. 2 shows a cross sectional perspective view of front knife area 200 shown in FIG. 1 and a chip gate 14. A book 109 is present in front knife area 200. Book 109 is supported and transported by transport conveyor 140 (FIG. 5). When book 109 is positioned so that a front edge trim location of book 109 is directly below upper knife 104, and carriage 101 is traveling at a same horizontal velocity as book 109, clamp 105 engages book 109 and upper knife 104 is reciprocated downward so that upper knife 104 quickly contacts lower knife 103, thereby trimming a front edge of book 109. Eccentric crank 102 may slide upper knife assembly 45 via linear slides 106 to reciprocate upper knife 104 downward. In a preferred embodiment, engaging book 109 with clamp 105 and trimming book 109 with knives 103, 104 is a precise process to ensure that book 109 is trimmed at a proper position with minimal chipout and to ensure efficient operation of the flying trimmer. Chip gate 14 may be provided to assure that book 109 is transported to front knife area 200 in a proper orientation, with respect to knives 103, 104 and clamp 105.

FIG. 3 shows a perspective view of lower knife area 201 shown in FIG. 1. In FIG. 3, the view of posts 107 is unobstructed by bearing blocks 47 (FIG. 1). Posts 107 protrude away from carriage 101 a sufficient amount to allow bearing blocks 47 (FIG. 1) to securely slide up and down on posts 107, thereby engaging and disengaging clamp 105 from books that pass through front knife area 200. Linear slides 106 may adjustably mount upper knife assembly 45 (FIG. 1) to carriage 101 and protrude from carriage 101 in a manner allowing upper knife assembly 45 (FIG. 1) to reciprocate downwards and trim books by contacting knife 103 with knife 104 (FIG. 1), then reciprocate upward a sufficient distance to allow books to pass between knives 103, 104 (FIG. 1).

FIG. 4 shows a perspective view of a portion of an infeed device 130 advancing books 109a, 109b, 109c to the embodiment of front knife area 200 shown in FIG. 1, which is shown schematically by lower knife 103, upper knife 104, and clamp 105. Spines of books 109b, 109c are driven against respective register lugs 110b, 110c by continuous infeed belts 11. Infeed belts 11 may have a higher velocity than register lugs 110a, 110b, 110c, thus register lugs 110a, 110b, 110c, when contacting books 109a, 109b, 109c, maintain positioning of the spines of books 109a, 109b, 109c, respectively. Register lugs 110a, 110b, 110c may be fixedly attached to continuous register belts 55, which may travel parallel to infeed belts 11 as lugs 110a, 110b, 110c contact books 109a, 109b, 109c. Register lugs 110b, 110c are spine registering books 109b, 109c so books 109b, 109c are in proper alignment to be trimmed by knives 103, 104 of front knife area 200. Lug 110a spine registered book 109a, then descended out of contact with book 109a as book 109a was engaged by forwarding belts 12, 13. Belts 11, 12, 13 are driven by motors. In one embodiment belts 11, 12, 13 are driven by servo motors.

Forwarding belts 12, 13 maintain a proper orientation of book 109a as book 109a enters front knife area 200 for trimming. Forwarding belts 12, 13 may be positioned close to knives 103, 104 to ensure proper orientation of books 109a, 109b, 109c being passed from infeed device 130 to a front edge trim position in front knife area 200. Chip gate 14 may be supporting a portion of book 109a not engaged by forwarding belts 12, 13, to ensure proper orientation of book 109a, so book 109a is effectively front trimmed and advanced through the flying trimmer. Chip gate 14, when provided, may reciprocate back and forth in a manner corresponding to the travel of books 109a, 109b, 109c.

FIG. 5 shows a schematic side view of infeed device 130, lower knife 103, upper knife 104, and clamp 105 shown in FIG. 4, and a downstream transport conveyor 140. Transport conveyor 140 will receive books 109a, 109b from infeed device 130 and maintain proper orientation of books 109a, 109b during front edge trimming by knives 103, 104. Book 109a is beginning to be passed by forwarding belts 12, 13 over knife 103 and under knife 104 into a nip 31 formed by an upper transport belt 27 and a lower transport belt 28 of transport conveyor 140. Chip gate 14 may briefly move in a direction 22 that book 109a is traveling as book 109a is advanced from infeed device 130 to transport conveyor 140, helping maintain orientation of book 109a as book 109a spans a space between infeed device 130 and transport conveyor 140.

Belt 27 interacts with pulleys 15, 16, 17, 20, 24 and belt 28 interacts with pulleys 18, 19, 25, 26. Pulleys 20, 24, 25, 26 may be fixed to ground. Pulleys 15, 16, 17, 18, 19, which are each marked with an “x” in FIG. 5, may be mounted on reciprocating front knife carriage carriage 101 (FIG. 1). Pulleys 15, 16, 17, 18, 19 may be reciprocated back and forth in relation to a travel direction 22 of book 109a with front knife carriage 101 as front knife carriage 101 (FIG. 1) is reciprocated back and forth in relation travel direction 22 of book 109a. Thus, a section of transport conveyor 140 is horizontally reciprocated along with knives 103, 104 and clamp 105. Pulleys 20, 24, 25, 26 do not reciprocate horizontally with knife carriage 101.

Transport conveyor 140 is driven by a servo motor 301, which matches the motion of front knife carriage 101 while front knives 103, 104 are trimming books 109a, 109b. Using servo motor 301 to drive transport conveyor 140 allows books 109a, 109b to travel through printing press finishing operations at a high velocity. Servo motor 301 can drive one of pulleys 24, 25, which can be geared together. Alternatively, a separate servo motor may drive each pulley 24, 25 or servo motor 301 may drive one or more other pulleys of transport conveyor 140 in place of or in addition to pulleys 24, 25.

As carriage 101 (FIG. 1) travels in direction 22, away from infeed device 130, a belt span 29 between pulleys 19, 26 may lengthen a certain amount while belt span 30 between pulleys 18, 25 may shorten the same amount. Also, as carriage 101 (FIG. 1) travels in direction 22, away from infeed device 130, a belt span 21 between pulleys 17, 20 may lengthen a certain amount while a belt span 23 between pulleys 16, 24 may shorten the same amount. Carriage 101, along with pulleys 15, 16, 17, 18, 19, reciprocates in direction 22 while knives 103, 104 trim book 109a.

As carriage 101 (FIG. 1) travels in a direction opposite direction 22, toward infeed device 130, belt span 29 between pulleys 19, 26 may shorten a certain amount while belt span 30 between pulleys 18, 25 may lengthen the same amount. Also, as carriage 101 (FIG. 1) travels in a direction opposite direction 22, toward infeed device 130, belt span 21 between pulleys 17, 20 may shorten a certain amount while belt span 23 between pulleys 16, 24 may lengthen the same amount. Equal belt span adjustment of belt spans 21, 23 and of belt spans 29, 30 provides the advantage that belts 27, 28 need not be stretched as pulleys 15, 16, 17, 18, 19 move back and forth horizontally.

In an alternative embodiment rolls may replace each upper belts 12, 27. The rolls may be positioned, in relation to respective lower belts 13, 28, so that rolls act with respective lower belts 13, 27 to maintain the position of books passing between infeed device 103 and transport conveyor 140. The rolls may also be raised and lowered to come into contact and come out of contact with passing books. Belts 13, 28 may also be substituted with brushes or any other mechanisms that will marry books to respective lower belts 12, 27 to maintain the orientation of the books as books are transported by belts 12, 27.

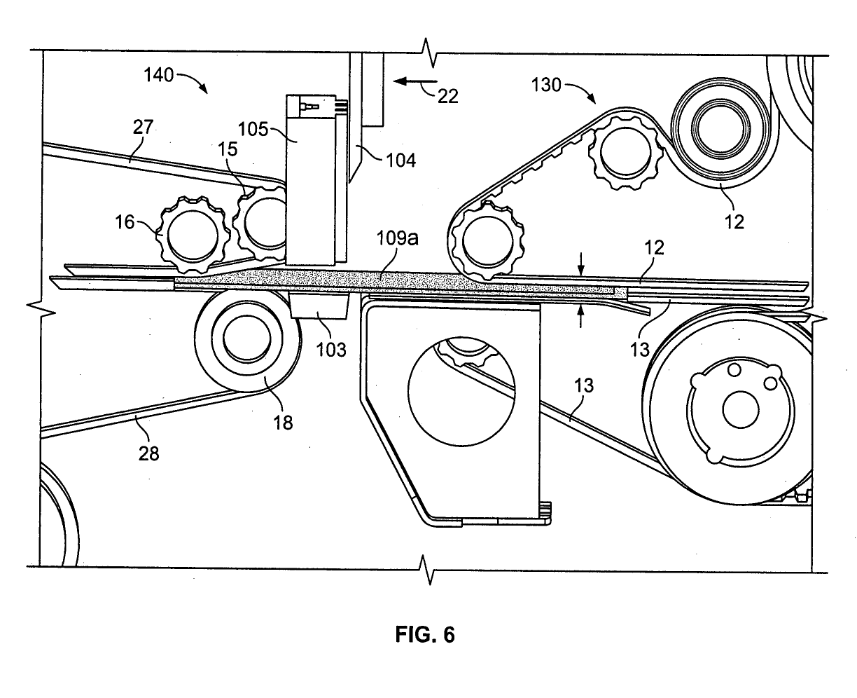

FIG. 6 shows a schematic side view of the embodiment shown in FIG. 5 with a book passing from infeed device 130 to transport conveyor 140. Book 109a is under the control of both forwarding belts 12, 13 and transport belts 27, 28. In a preferred embodiment, book 109a is positively transferred from forwarding belts 12, 13 to transport belts 27, 28 with belts 12, 13, 27, 28 traveling at substantially a same velocity. Clamp 105 may be moving downward to clamp book 109a when book 109a is in proper position to be front edge trimmed by knives 103, 104. Carriage 101 (FIG. 1), along with pulleys 15, 16, 18, knives 103, 104 and clamp 105, is being reciprocated horizontally in a direction opposite direction 22, toward infeed device 130.

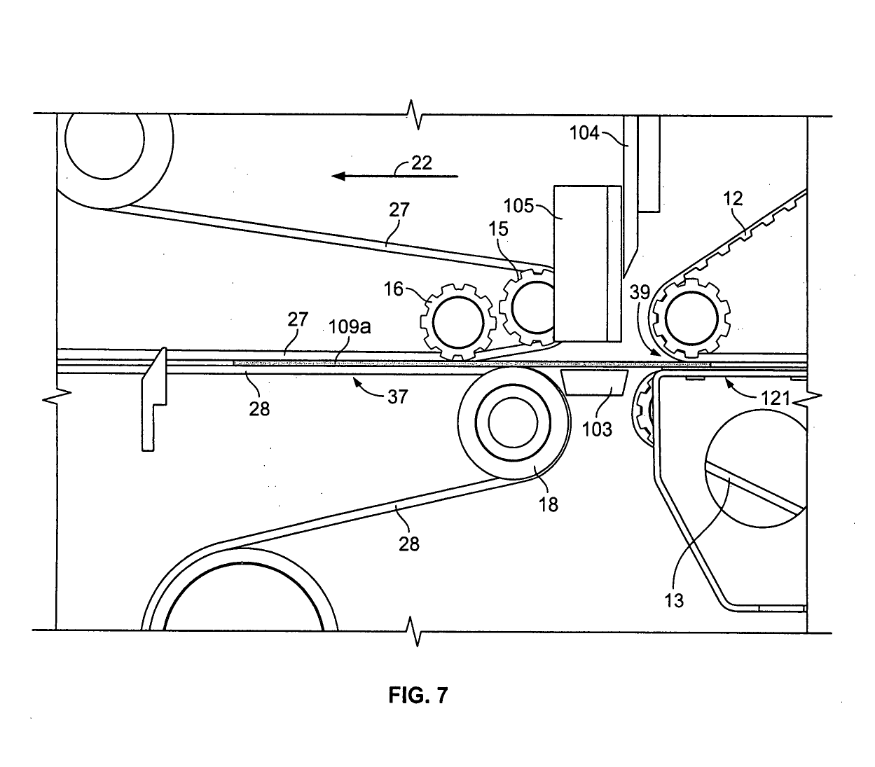

FIG. 7 shows a schematic side view of the embodiment shown in FIG. 5 with book 109a being released by infeed device 130 as book 109a is transported by transport conveyor 140. Book 109a is passing through a space under clamp 105 and knife 104 and above knife 103. After book 109a is released by forwarding belts 12, 13 book 109a may be exclusively under control of transport belts 27, 28. A point at which belts 12, 13 last control book 109a is determined by a position of a trailing end 121 of book 109a and a position of a nip 39 formed by forwarding belts 12, 13. After forwarding belts 12, 13 release control of book 109a, transport belts 27, 28 and forwarding belts 12, 13 may run at different velocities. A velocity of transport conveyor 140 may be dynamically adjusted so that when clamp 105 engages book 109a, book 109a may be traveling at substantially the same velocity as carriage 101 and clamp 105. Carriage 101, along with pulleys 15, 16, 18, knives 103, and clamp 105, is being reciprocated in a direction opposite direction 22, toward infeed device 130.

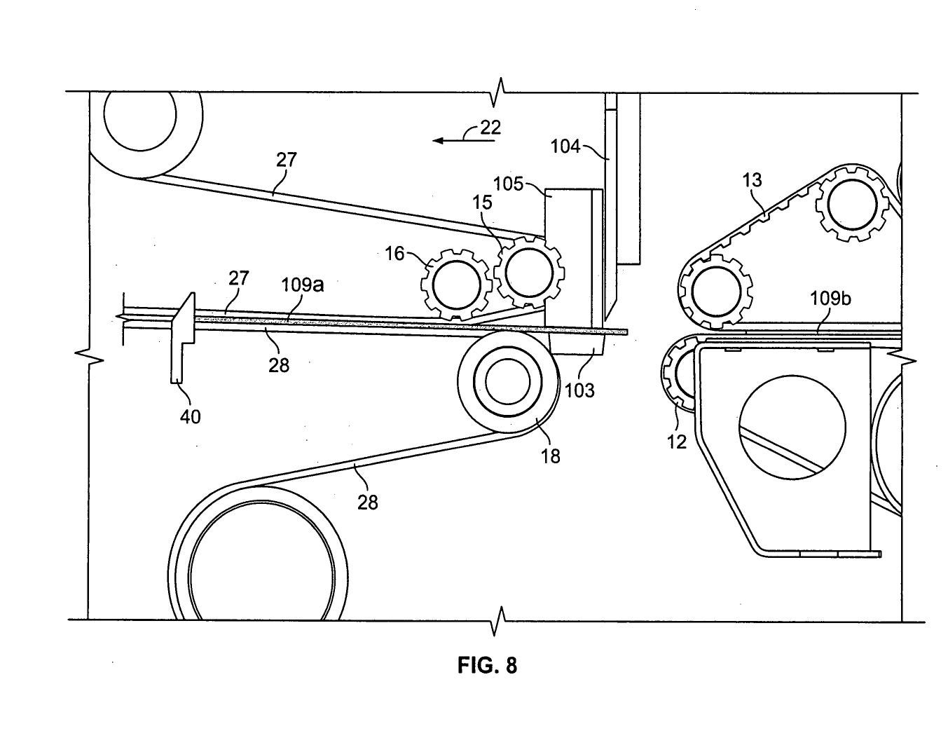

FIG. 8 shows a schematic side view of the embodiment shown in FIG. 5 with clamp 105 applying pressure to book 109a as transport conveyor 140 transports book 109a. Upper knife 104 is being oscillated downward to trim a front edge of book 109a at a predetermined proper location. Upper knife 104 will trim book 109a and contact lower 103 as clamp 105 (FIG. 1) securely engages book 109a. Eccentric crank 102 (FIG. 1) is reciprocating carriage 101 (FIG. 1), along with pulleys 15, 16, 18, knives 103, 104 and clamp 105, in direction 22, away from infeed device 130, as clamp 105 applies pressure to book 109a. Carriage 101 (FIG. 1) may be traveling at substantially the same horizontal velocity as belts 27, 28, as well as book 109a, as clamp 105 is contacting book 109a and while knives 103, 104 trim book 109a. Clamp 105 applies pressure to book 109a without disrupting the position or velocity of book 109a, thus helping to eliminate chipout during trimming and increasing the efficiency of the flying trimmer.

Backstops 40 may also be provided to improve the accuracy of the front edge trimming of book 109a by knives 103, 104. When backstops 40 are not employed, belts 27, 28 provide sufficient pressure to prevent book 109a from slipping as book 109a is engaged by clamp 105 and trimmed by knives 103, 104. When backstops 40 are employed, belts 27, 28 can provide less pressure on book 109a so that book 109a can slide in belts 27, 28 as book 109a hits and is aligned by backstop 40. Backstop 40 may also be utilized to skew the trimming by knives 103, 104, if necessary to compensate for errors in cover printing and folding.

Belts 12, 13 may be advancing book 109b to belts 27, 28 so that book 109b can subsequently been front edge trimmed by knives 103, 104.

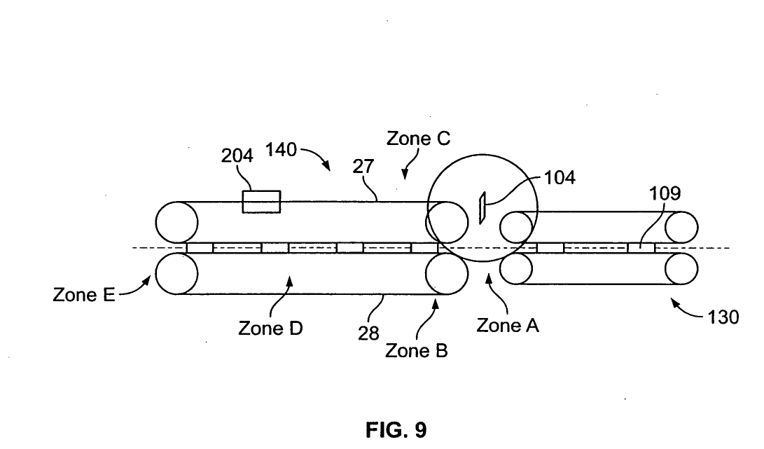

FIG. 9 shows a highly schematic view of the embodiment of the shown in FIGS. 5 to 8 with side knives 204 added. Books 109 travel through infeed device 130 and under upper knife 104 to downstream transport conveyor 140, which transports books 109 under side knives 204. Books 109 are successively transported by infeed device 130 at a constant horizontal velocity toward transport conveyor 130. After each book 109 passes to transport conveyor 130 upper front knife 104 reciprocates downward and trims a front edge of each book 109. As each book 109 is passed from infeed device 130 to transport conveyor 140, servo motor 301 (FIG. 5) adjusts a horizontal velocity of transport conveyor 140 to match a horizontal velocity of infeed device 130. An area where books 109 are passed to transport conveyor 140 by infeed device 130 is designated as Zone A for illustrative purposes.

After infeed device 130 releases control of book 109 to transport conveyor 140, servo motor 301 (FIG. 5) adjusts a horizontal velocity of transport conveyor 140 so that the horizontal velocity of book 109 matches a horizontal velocity that front knife 104 is driven by drive motor 300 (FIG. 1) as front knife 104 trims book 109. Because front knife 104 is driven along with a reciprocating section of conveyor 140, the horizontal velocity that belts 27, 28 transport book 109 may be equal to the horizontal velocity that a reciprocating section of conveyor 140 is driven by drive motor 300. An area where books 109 are front edge trimmed by knife 104 while books 109 are transported by transport conveyor 140 is designated as Zone B for illustrative purposes.

After each book 109 is front edge trimmed transport conveyor 140 will then transport each book 109 to be side edge trimmed by side knives 204. Side knives 204 may be supported by a side knife carriage, which may include components similar to components of front knife carriage 101 (FIG. 1). The side knife carriage may operate reciprocally in a manner similar to front knife carriage 101, via a side knife eccentric crank similar to eccentric crank 102 (FIG. 1). The side knife eccentric crank may also reciprocate side knives 204 vertically to side edge trim books 109. Drive motor 300 may also drive the side knife eccentric crank, reciprocating side knives 204 horizontally and vertically. Alternatively, the side knife eccentric crank may be driven by a separate drive motor.

As each book 109 is transferred between front knife 104 and side knives 204 servo motor 301 will adjust the horizontal velocity of transport conveyor 140 so that each book 109 will be traveling at the same horizontal velocity as side knives 204 when side knives 204 begin to side edge trim book 109. An area where books 109 are transferred between front knife 104 and side knives 204 by transport conveyor 140 is designated as Zone C for illustrative purposes.

Servo motor 301 then adjusts the horizontal velocity of transport conveyor 140 so that as side knives 204 side edge trim each book 109 transport conveyor 140 is transporting each book 109 at a same horizontal velocity as side knives 204 are traveling. An area where books 109 are side edge trimmed by knives 204 while books 109 are transported by transport conveyor 140 is designated as Zone D for illustrative purposes.

After each book 109 is side edged trimmed, transport conveyor 140 will transfer each book 109 away from transport conveyor, possibly to another subsequent finishing station. When books are transferred to another subsequent finishing station servo motor 301 may adjust a horizontal speed of transport conveyor 140 to match a transport device of the subsequent finishing station while each book is transferred. An area where books are transferred away from transport conveyor 140 is designated as Zone E for illustrative purposes. After Zone E, transport conveyor 140 returns to Zone A and a transport cycle is repeated.

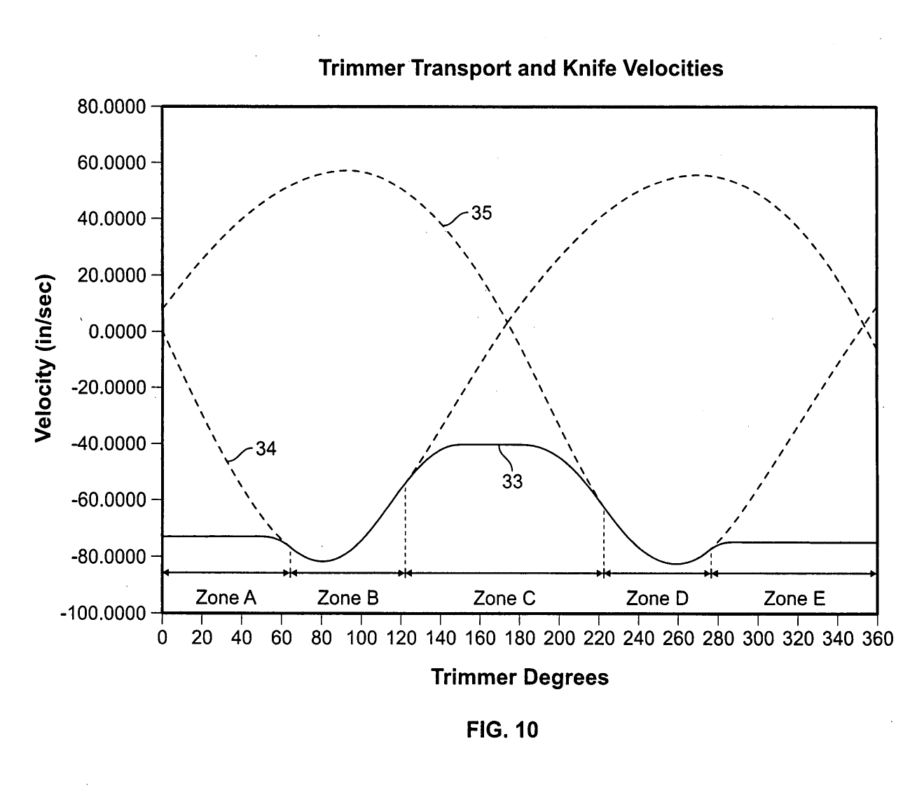

FIG. 10 shows a graph of horizontal velocities of front knife 104, side knives 204 and transport conveyor 140 for complete revolutions of front knife 104 and side knives 204 according to the embodiment of the present invention shown in FIG. 9.

A velocity of transport conveyor 140 is shown by a curved line 33, a velocity of front knife 104 is shown by a curved dotted line 34 and a velocity of side knives 204 is shown by a curved dotted line 35. Transport conveyor 140 runs at varying velocities during each revolution of front knife 104 and side knives 204. Front knife 104 and side knives 204 reciprocate back and forth horizontally, therefore the horizontal velocities of front knife 104 and side knives 204 shift between positive and negative velocities. A direction of travel 22 of book 109a, as shown in FIGS. 5 to 8, is defined as a direction of negative velocity for illustrative purposes related to FIG. 10.

In Zone A, servo motor 301 drives transport conveyor 140 to match a horizontal infeed velocity of books 109 as books 109 are received by transport conveyor 140 from infeed device 130. In Zone B, servo motor 301 drives transport conveyor 140 to match a horizontal velocity front knife 104 as front knife 104 front edge trims books 109. In Zone C, servo motor 301 drives transport conveyor 140 to transfer books 109 between front knife 104 and side knives 204 so that as side knives 204 first contact books 109 transport conveyor 140 has a-horizontal velocity that equals the horizontal velocity of side knives 204. In Zone D, servo motor 301 drives transport conveyor 140 so that as books 109 are being trimmed by side knives 204 books 109 are traveling at the same horizontal velocity of books 109. In Zone E, servo motor 301 drives transport conveyor 140 to transfer books 109 away from transport conveyor 140 and possibly towards a subsequent finishing station.

In an alternative embodiment front knife carriage 101 is substantially synchronized with the side knife carriage, so that as one book is being side trimmed by side knives 204 a following book may be front trimmed by front knives 103, 104, with the horizontal velocities of front knife carriage 101 and the side knife carriage substantially equaling the velocity of belts 27, 28. 100461 FIG. 11 shows pulleys 15, 16, 17, 18, 19 shown in FIG. 5 mounted on front knife carriage 101 shown in FIG. 1. Pulleys 15, 16, 17, 18, 19 are mounted on front knife carriage 101 (FIG. 1), in front knife area 200, near levers 43, 44.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A book trimmer comprising:
an edge trimming knife driven by a drive motor; and
a conveyor downstream of the edge trimming knife driven by a servo motor, the drive motor also driving a section of the conveyor.

2. The book trimmer recited in claim 1 wherein the conveyor transports a book to the edge trimming knife to be trimmed and the edge trimming knife trims the book.

3. The book trimmer recited in claim 2 wherein the servo motor drives the conveyor so the conveyor operates at a speed equal to a speed of the edge trimming knife as the edge trimming knife trims the book.

4. The book trimmer recited in claim 1 further comprising a second edge trimming knife downstream of the edge trimming knife.

5. The book trimmer recited in claim 4 wherein the second edge trimming knife is also driven by the drive motor.

6. The book trimmer recited in claim 4 wherein the conveyor transports a book to the second edge trimming knife to be trimmed and the second edge trimming knife trims the book.

7. The book trimmer recited in claim 4 wherein the servo motor drives the conveyor so the conveyor transports a book at a speed equal to a speed of the second edge trimming knife as the edge trimming knife trims the book.

8. The book trimmer recited in claim 1 wherein the conveyor is comprised of a belt and a pulley and the servo motor drives the pulley.

9. The book trimmer recited in claim 1 wherein the conveyor is comprised of:
a first pulley;
a first belt traveling over the first pulley;
a second pulley; and
a second belt traveling over the second pulley;
the servo motor driving the first pulley and the second pulley being geared to the first pulley.

10. The book trimmer recited in claim 1 further comprising a second servo motor wherein the conveyor is comprised of:
a first pulley;
a first belt traveling over the first pulley;
a second pulley; and
a second belt traveling over the second pulley;
the servo motor driving the first pulley and the second servo motor driving the second pulley.
